(19) United States
(12) Patent Application Publication
(10) Pub. No.: US 2004/0242046 A1
(43) Pub. Date: Dec. 2, 2004

(54) Electrical connector

(75) Inventors: Tomonari Ohtsuki, Tokyo (JP); Yasue Yamazaki, Tokyo (JP)

Correspondence Address: BAKER & BOTTS, 30 ROCKEFELLER PLAZA, NEW YORK, NY, 10112

(73) Assignee: DDK Ltd.

(21) Appl. No.: 09/998,565

(22) Filed: Nov. 16, 2001

(30) Foreign Application Priority Data
Nov. 22, 2000 (JP) 2000-355,367

(51) Int. Cl. H01R 13/62

(52) U.S. Cl. 439/329

(57) ABSTRACT

An electrical connector includes a housing having a fitting opening for a mating connector, a flexible printed circuit board having electric contact elements capable of detachably fitting with the mating connector, a block embracing the flexible printed circuit board with the housing, bit inserts causing the block and the housing to be engaged with each other, and urging members for urging the flexible printed circuit board to a substrate. The housing is provided with at least two positioning pins as positioning device with respect to the block. The positioning pins are able to be slightly press-fitted in insertion apertures of the flexible printed circuit board. The block is provided with positioning apertures at locations corresponding to the positioning pins of the housing.

### BACKGROUND OF THE INVENTION

This invention relates to an electrical connector adapted to be fitted with a ball grid array chip (mating connector) having a plurality of electric contacts, and more particularly to a positioning construction for positioning a housing and a block constituting the electrical connector of a socket construction.

A socket construction for a ball grid array chip and an electrical connector has been proposed by the applicant of the present application in Japanese Patent Application Opened No. 2000-150,034 (Japanese Patent Application No. H10-341,135). A construction of an electrical connector 70 of the prior art utilizing the socket construction will be explained by referring to FIGS. 4A and 4B and 5. As shown in FIG. 5, a ball grid array chip (mating connector) can be detachably mounted on the socket construction which will be explained.

The electrical connector of the prior art mainly comprises a housing 72, a block 74, a flexible printed circuit board 26 (referred to as “FPC board” hereinafter), bit inserts 42 and urging members 16. The respective components and a mounting method of the FPC board will be explained.

The block 74 is formed with an elastic member insertion groove 40 for receiving an elastic member (for example, silicone rubber or the like) and with inclined portions 32 at both the ends in the width directions for guiding the FPC board 26 to pads 24 of a substrate 22. Moreover, the block 74 is formed with positioning pins 36 for positioning the housing 72 and the elastic member and with press-fitting holes 44 for fixing the bit inserts 42 therein.

The housing 72 is formed with a fitting opening 20 for detachably inserting a mating connector therein and with projections 28 at both the ends in the width directions for urging the FPC board 26 to the substrate 22. The projections 28 are each formed with an insertion groove 34 for receiving an urging member 16. Moreover, the housing 72 is formed with positioning apertures 38 at locations corresponding to the positioning pins 36 of the block 74 and with apertures for set screws 18.

On the other hand, the FPC board 26 is provided with a plurality of electric contact elements adapted to detachably contact electric contacts of a mating connector and is formed with insertion apertures formed at locations corresponding to the positioning pins 36 and adapted to be slightly press-fitted with the positioning pins 36 of the block 74.

The construction for electrically connecting a plurality of electric contact elements of the FPC board and a plurality of electric contacts of the mating connector has been proposed by the applicant of the present application in Japanese Patent Application Opened No. 2000-67,972 (Japanese Patent Application No. H10-246,557), in which U-shaped slits are formed around the electric contact elements to provide the elasticity to the electric contact elements.

The bit inserts 42 are substantially cylindrical. The set screws 18 are threaded or screwed into the bit inserts 42 to fix the housing 72 and the block 74 together. For this purpose, the bit inserts 42 are each formed with internal threads for the set screw 18 on the upper side and with a fixing pin 48 on the lower side for positioning the bit insert 42 with respect to the substrate 22.

Finally, the mounting method of the FPC board 26 will be explained.

In the first step, the bit inserts 42 are fixed to the substrate 22 by soldering.

In the second step, the block 74 is press-fitted onto the bit inserts 42 fixed to the substrate 22, and an elastic member is arranged in the elastic member insertion groove 40 of the block 74. The elastic member is formed with positioning apertures (not shown) into which the positioning pins 36 of the block 74 are inserted, thereby positioning the elastic member.

In the third step, the FPC board 26 is mounted on the block 74 under the condition obtained in the second step. In mounting the FPC board 26, the positioning pins of the block 74 are aligned with the insertion apertures of the FPC board 26 and slightly press-fitted thereinto.

In the fourth step, the housing 72 having the urging members 16 received therein is set onto the block 74 under the condition obtained in the third step such that the positioning pins 36 of the block 74 are aligned with the positioning apertures of the housing 72. Thereafter, the set screws 18 are tightly screwed into the bit inserts 42 to fix the housing to the block. As a result, the urging members 16 received in the housing 72 urge the FPC board 26 against the substrate 22 so that the FPC board 26 is urged against the pads 24 of the substrate 22.

In general, several tens of electrical connectors 70 are mounted on a substrate 22. In many cases, metal contacts of a mating connector (ball grid array chip) are formed by solder so that after electric contact elements of a flexible printed circuit board have contacted electric contacts of a mating connector several hundred times, the solder (PbSn) forming the metal contacts of the mating connector tends to adhere on gold-plated surfaces of the electric contact elements of the FPC board. The adhered solder is often oxidized to form an oxide (SnO₂), resulting into defective or failed electrical connection.

Owing to such an adherence of the solder to the electric contact elements, removal of the adhered solder therefrom is needed by the use of a brush every several ten times or hundred times of the contact between the electric contacts and the electric contact elements. Moreover, after the connection and disconnection between the FPC board of a connector and a mating connector have been repeated several hundred times or thousand times, the electric contact elements of the FPC board are worn off, resulting into defective or failed electrical connection so that the FPC board itself needs to be replaced.

In order to remove the solder accumulation on the electric contact elements of the FPC board and to replace the FPC board itself, it is needed to dismantled the electrical connector to an extent such that the electric contact elements subjected to brushing can be seen or the replacement of the FPC board becomes possible. In other words, the removal of the FPC board is absolutely necessary in any cases.

With the construction of the electrical connector whose positioning pins 36 of the block 74 are slightly press-fitted in the FPC board described above, however, the removal of the FPC board must be performed taking great care to prevent the FPC board 26 and the positioning pins 36 from being scratched. In order to remove FPC boards of several tens of electrical connectors mounted on a substrate, a fairly long time is required. For example, it would take about 100 minutes to remove sixty-four FPC boards 26. During such a long time, apparatuses (electronic appliances) associated therewith could not be operated, which would be a pending problem to be solved.

In the construction of the prior art, moreover, in order to slightly press-fit a new FPC board 26 with the positioning pins 36 of the block 74, a jig for the press-fitting is needed and it is difficult to position the jig at the location where the electrical connector is mounted so that a fairly long time is needed for such a slight press-fitting. For example, it takes about forty-five minutes to slightly press-fit sixty-four FPC boards 26 on the positioning pins 36 of the blocks 74. During such a long time, apparatuses in connection therewith could not be operated.

With the construction of the prior art, therefore, it will take about 145 minutes in order to replace FPC boards 26 of several tens of electrical connectors mounted on the substrate 22, during which the associated apparatuses could not be operated, increasing the operating costs.

In case of removing the solder accumulation on the electric contact elements of the FPC boards, it will take much time to replace the FPC boards 26 (for example, 145 minutes for the replacement of sixty-four FPC boards 26), at the same time it is required to clean the contacting portions of the FPC boards 26 for a longer time (for example, about 450 minutes for cleaning sixty-four FPC boards 26). During such a long time, the apparatuses could not be operated.

In case of removing the solder accumulation, it may be conceived to replace old FPC boards with previously prepared FPC boards in order to reduce the time for the apparatuses being stopped. In such a method, however, it will still take much time to replace the FPC boards, during which the apparatuses could not be operated.

In any cases, with the construction of the prior art, it will take much time to replace the FPC boards, during which associated apparatuses could not be operated.

### SUMMARY OF THE INVENTION

It is an object of the invention to provide an improved electrical connector which eliminates all the disadvantages of the prior art and which is capable of easily replacing FPC boards without stopping associated apparatuses for a long time and providing correct electrical connections without any defective electrical connection.

In order to accomplish the object, in an electrical connector including a housing having a fitting opening for a mating connector, a flexible printed circuit board having electric contact elements capable of detachably fitting with the mating connector, a block embracing said flexible printed circuit board with said housing, bit inserts causing said block and said housing to be engaged with each other, and urging members for urging said flexible printed circuit board to a substrate, according to the invention said housing is provided with at least two positioning pins as positioning means with respect to said block, said positioning pins being able to be slightly press-fitted in insertion apertures of said flexible printed circuit board, and said block is provided with positioning apertures at locations corresponding to said positioning pins of said housing.

The housing is provided with projections for urging the FPC board. Preferably, the projections are formed with chamfered portions at contacting portions with the FPC board for preventing it from being scratched.

The positioning apertures of the block are preferably approximately 0.005 mm to 0.02 mm larger than the positioning pins of the housing.

The electrical connector thus constructed according to the invention brings about the following significant effects.

(1) The positioning pins for positioning the housing, the block and the FPC board are provided on the housing so that the FPC board belongs to the housing or is secured to the housing. Accordingly, when the housing is removed from the block, the FPC board is removed together with the housing, thereby facilitating the removal of the FPC board from the block mounted on a substrate.

(2) As the FPC board can be easily removed from the block mounted on the substrate described above, by previously preparing a further set of a housing having a flexible printed circuit board mounted thereon, there is no need to stop associated apparatuses for a long time during the replacement of the FPC boards even if several tens of electrical connectors are mounted on a substrate. For replacing flexible printed circuit boards for sixty-four electrical connectors, it takes only about 45 minutes which is considerably reduced from the time required in prior art electrical connectors.

(3) There is no need for a jig for press-fitting the positioning pins of a block into positioning apertures of a FPC board as in the prior art so that there is no need for the troublesome operations and much time for positioning the jig.

(4) The positioning pins provided on the housing serve to position the block and FPC board in the same manner as conventional electrical connectors, thereby avoiding any defective electrical connection.

The invention will be more fully understood by referring to the following detailed specification and claims in connection with the appended drawings.

### BRIEF DESCRIPTION OF THE DRAWINGS

FIG. 1 is a perspective view illustrating an electrical connector according to the invention mounted on a substrate;

FIG. 2A is a plan view of the electrical connector shown in FIG. 1;

FIG. 2B is a cross-sectional view of the electrical connector taken along the line A-A in FIG. 2A;

FIG. 3 is a longitudinal sectional view of the electrical connector taken along the line B-B in FIG. 2A;

FIG. 4A is a plan view of the electrical connector of the prior art;

FIG. 4B is a cross-sectional view of the electrical connector taken along the line C-C in FIG. 4A; and

FIG. 5 is a longitudinal sectional view of the electrical connector taken along the line D-D in FIG. 4A.

### DESCRIPTION OF THE PREFERRED EMBODIMENTS

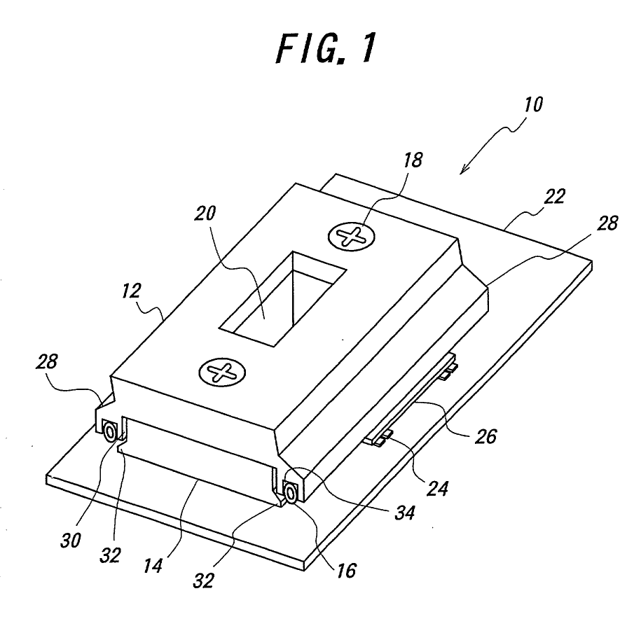

An electrical connector according to one embodiment of the invention will be explained by referring to the drawings. FIG. 1 illustrates in a perspective view the electrical connector 10 mounted on a substrate. The electrical connector 10 mainly comprises a housing 12, a block 14, a flexible printed circuit board (FPC board) 26, urging members 16 and bit inserts 42. These components and mounting and removing methods of the FPC board will be explained hereinafter.

The electrical connector 10 is fixed to a substrate 22 by soldering the bit inserts 42 to the substrate 22. In the illustrated embodiment, sixty-four electrical connectors are mounted on the substrate 22.

First, the housing 12 will be explained, which is one subject component of the electrical connector. The housing 12 is formed with a fitting opening 20 therethrough for fitting a mating connector therein and with apertures for set screws 18 at predetermined positions, which may be at least two to obtain a mounting stability.

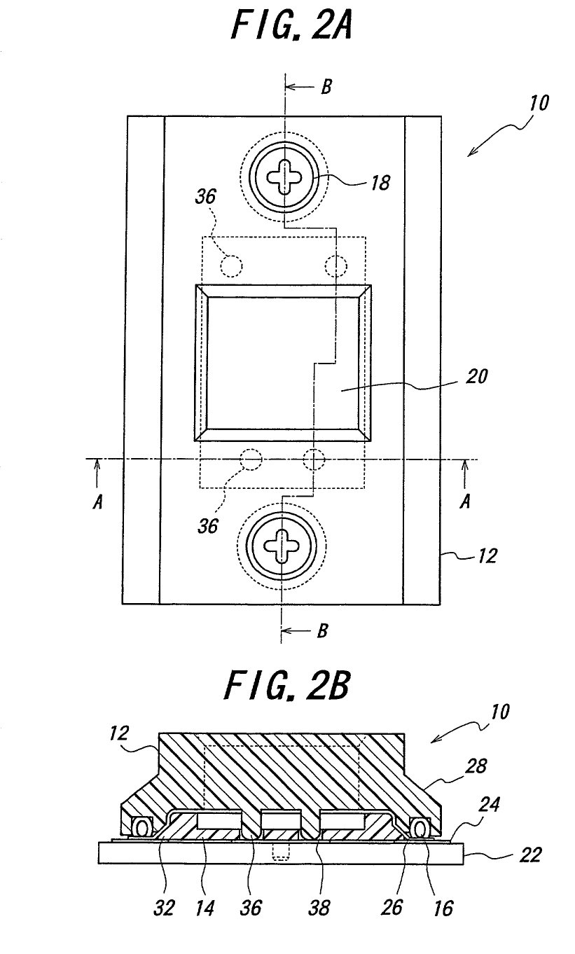

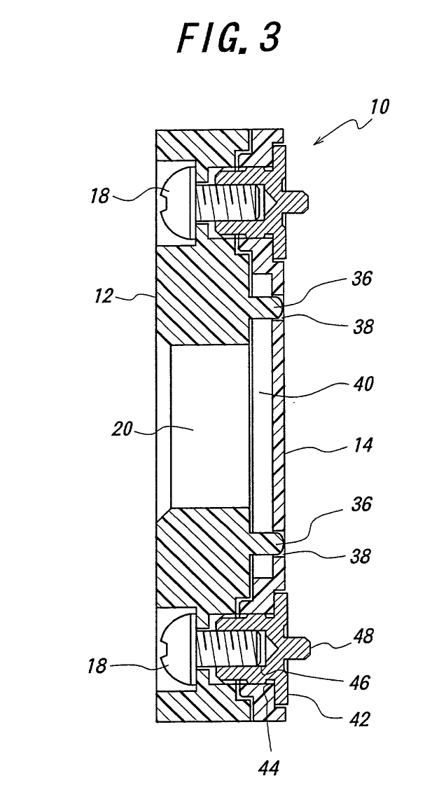

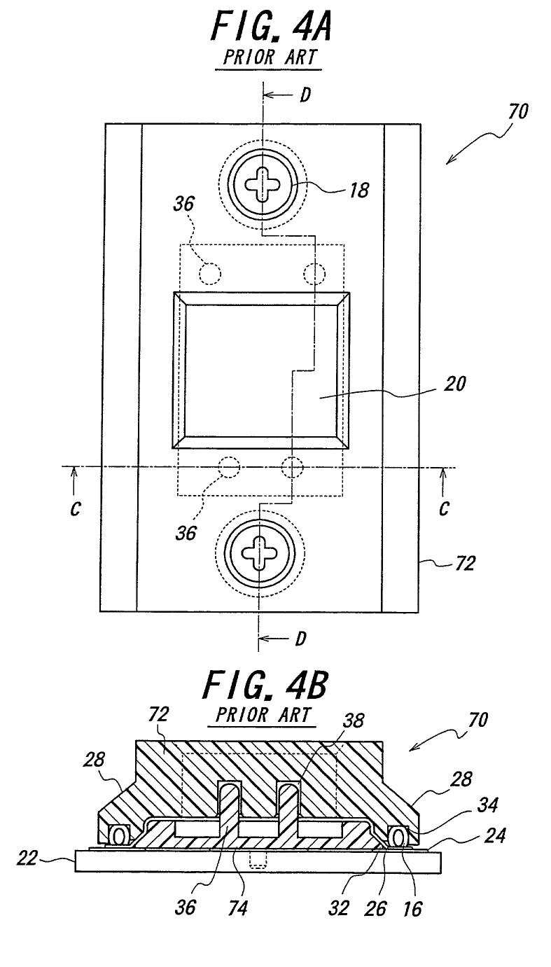

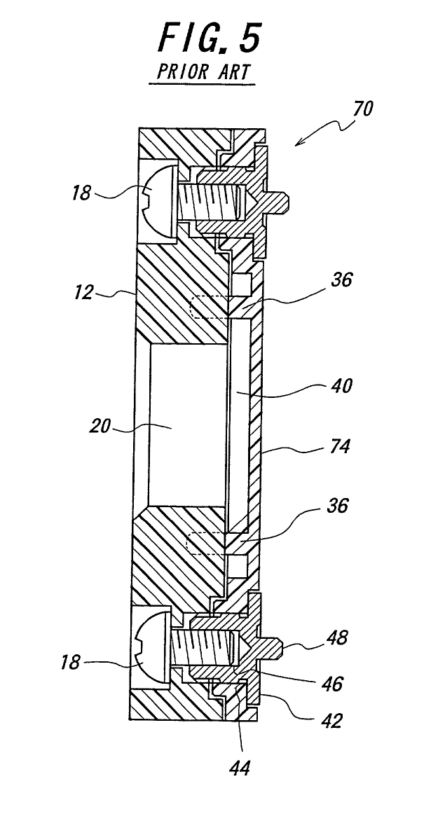

The housing 12 is further provided with a plurality of positioning pins 36 (FIGS. 2 and 3) extending toward the block 14 at predetermined positions. These positioning pins 36 serve to position the housing 12, block 14 and FPC board. The number and size of the positioning pins 36 may be determined by the size of the electrical connector 10 and the strength and size of the block 14 and FPC board 26. The number of positioning pins 36 is at least two in consideration of positioning function, four in the illustrated embodiment. The positions of the pins 36 are determined according to the size and strength of the FPC board 26.

As shown in FIG. 1, moreover, the housing 12 is provided with projections 28 at both the ends in the width directions for urging the FPC board 26 against the pads 24 of the substrate 22 to connect between the FPC board 26 and the pads 24. The projections 28 are each provided with an insertion groove 34 receiving an urging member 16 for urging the FPC board 26. The projections 28 may be in any shape so long as capable of urging the FPC board 26 against the pads 24 of the substrate 22 and preferably formed with chamfered portions at contacting portions with the FPC board 26 for preventing the FPC board 26 from being scratched. The size of the projections 28 may be determined in consideration of the strength and workability of the housing.

The housing 12 is injection molded from an insulating plastic material. Preferred materials from which to form the housing 12 include polybutylene terephthalate (PBT), polyamide (PA), liquid crystal polymer (LCP) and polyphenylene sulfide (PPS).

The block 14 will then be explained. The block 14 is formed with positioning apertures 38 at positions corresponding to the positioning pins 36 of the housing 12. The positioning apertures 38 are approximately 005 mm to 0.02 mm larger than the positioning pins 36 for their positioning function.

The block 14 is further formed with an elastic member insertion groove 40 somewhat larger than and at a location corresponding to the fitting opening 20 of the housing 12 for receiving an elastic member. Moreover, the block 14 is formed with press-fitting holes 44 at positions corresponding to the set screws 18 in the housing 12 for press-fitting the bit inserts 42. The size of the press-fitting holes 44 may be determined in consideration of the strength of the block 14 and the holding force for the bit inserts 42.

Furthermore, the block 14 is formed with inclined portions 32 at both the ends in the width directions for introducing the FPC board 26 to the pads 24 of the substrate 22. The shape of the inclined portions 32 may be in any shape so long as it facilitates the introduction of the FPC board 26.

The block 14 is injection molded from an insulating plastic material which is similar to those for the housing 12.

The FPC board 26 will be explained. The FPC board is as explained in the paragraphs of the prior art. The construction of the FPC board for electrically connecting a plurality of electric contact elements of the FPC board to a plurality of electric contacts of a mating connector has been proposed in Japanese Patent Application Opened No. 2000-67,972 (Japanese Patent Application No. H10-246,557) by the applicant of the present case. In that case, the board is formed with U-shaped grooves around the electric contact elements to provide the elasticity to the contact elements. Moreover, an elastomer is arranged in the elastic member insertion groove to ensure the stable contact with the aid of the elastomer when the mating connector is inserted.

Finally, a mounting method for the FPC board 26 will be explained.

In the first step, the bit inserts 42 are fixed to the substrate 22 as by soldering.

In the second step, the bit inserts 42 fixed to the substrate 22 are press-fixed in the block 14 and the elastic member is arranged in the elastic member insertion groove 40 of the block 14. The elastic member is formed with positioning apertures (not shown) at positions corresponding to the positioning pins 36 of the block 14 so that the elastic member is positioned by the insertion of the positioning pins 36 in the positioning apertures (not shown) of the elastic member.

In the third step, the FPC board 26 is slightly press-fitted with the housing 12 in a manner that the positioning pins 38 of the housing 12 are aligned with insertion apertures of the FPC board 26.

In the fourth step, the housing 12 under the condition obtained in the first step is mounted on the block 14 fixed to the substrate 22 such that the positioning pins 36 of the housing 12 are aligned with the positioning apertures 38 of the block 14.

In the fifth step, the housing 12 and the block 14 are completely fixed together by tightly threading or screwing the set screws 18 into the bit inserts 42. At the same time, the FPC board 26 is urged against the pads 24 of the substrate 22 by the urging members 16 settled in the projections 28 of the housing 12, whereby metallic portions of the FPC board and the pads 24 are electrically connected.

Before the second step, the third step may be carried out.

When it is required to remove the FPC board, after the set screws are removed, removal of housing 12 permits the FPC board 26 to be removed under the condition connected to the positioning pins 36 of the housing 12.

While the invention has been particularly shown and described with reference to preferred embodiments thereof, it will be understood by those skilled in the art that the foregoing and other changes in form and details can be made therein without departing from the spirit and scope of the invention.

What is claimed is:

1. An electrical connector including a housing having a fitting opening for a mating connector, a flexible printed circuit board having electric contact elements capable of detachably fitting with the mating connector, a block embracing said flexible printed circuit board with said housing, bit inserts causing said block and said housing to be engaged with each other, and urging members for urging said flexible printed circuit board to a substrate,
wherein said housing is provided with at least two positioning pins as positioning means with respect to said block, said positioning pins being able to be slightly press-fitted in insertion apertures of said flexible printed circuit board, and said block is provided with positioning apertures at locations corresponding to said positioning pins of said housing.

2. The electrical connector as set forth in claim 1, wherein said housing is provided with projections for urging said flexible printed circuit board against said substrate, said projections are formed with chamfered portions at contacting portions with said flexible printed circuit board for preventing it from being scratched.
